(19) United States
(12) Patent Application Publication
(10) Pub. No.: US 2023/0385394 A1
(43) Pub. Date: Nov. 30, 2023

(54) ONLINE SIGNATURE AUTHENTICATION SYSTEM AND METHOD BASED ON SOFT DYNAMIC TIME WARPING

(71) Applicant: South China University of Technology, Guangzhou (CN)

(72) Inventors: Lianwen JIN, Guangzhou (CN); Jiajia JIANG, Guangzhou (CN); Songxuan LAI, Guangzhou (CN); Huiyun MAO, Guangzhou (CN); Yecheng ZHU, Guangzhou (CN)

(21) Appl. No.: 18/319,571

(22) Filed: May 18, 2023

(30) Foreign Application Priority Data
May 26, 2022 (CN) 202210582 665.2

(51) Int. Cl. G06F 21/32; G06F 21/64; G06N 3/091

(52) U.S. Cl. CPC G06F 21/32; G06F 21/64; G06N 3/091

(57) ABSTRACT

An online signature authentication system and an online signature authentication method based on soft dynamic time warping are provided, the system includes a data acquisition module, a data preprocessing module, a signature sequence feature extraction neural network module and a signature sequence feature testing module; the method includes: acquiring the signature sequence to be tested; preprocessing the signature sequence, acquiring the preprocessed data and extracting the time functions of the signature sequence; constructing the neural network and training the neural network based on the time functions of the signature sequence to obtain the signature sequence feature extraction neural network; and based on the preprocessed data and through the signature sequence feature extraction neural network, judging the authenticity by calculating the dynamic time warping distance between the signature sequence features.

### CROSS-REFERENCE TO RELATED APPLICATIONS

This application claims priority to Chinese Patent Application No. 202210582665.2, filed on May 26, 2022, the contents of which are hereby incorporated by reference.

### TECHNICAL FIELD

The application belongs to a technical field of pattern recognition and artificial intelligence, and in particular to an online signature authentication system and a method based on soft dynamic time warping.

### BACKGROUND

Signature authentication is an important identity authentication technology, and its verification object is a signature of the writer or the abbreviation of the signature, which have a strong personal style because of frequent use. Compared with features such as faces, iris, fingerprints and voiceprints, handwritten signatures may be collected in a non-invasive and more user-friendly way, so the signature authentication has been widely used in business activities, banking services, security authentication and other scenarios. With widespread electronic devices in the information age, a technology of an online handwritten signature authentication has been widely developed, and the acquisition media have evolved from original special equipment for office scenarios to the current mobile terminals such as smart phones and electronic tablets. In these scenarios, the writer may flexibly choose to input with a stylus or with fingers. However, the online handwritten signature has a small number of samples, presents great intra-class differences in cross-time and cross-device scenarios, and are vulnerable to counterfeit signature attacks, thus bringing great challenges to the online signature authentication.

With the development of deep learning, an automatic signature authentication method based on big data and deep neural network gradually plays an important role, especially when combined with the classical dynamic time warping algorithm, the method can achieve more advanced results, indicating that dynamic time warping is very crucial for the online signature authentication. However, the conventional dynamic time warping algorithm is non-differentiable for the input, which results in failure of end-to-end trainings of the neural network.

### SUMMARY

The application provides an online signature authentication system and an online signature authentication method based on soft dynamic time warping. A neural network is constructed through a data normalization and a resampling processing, and the network is trained through a loss function based on a soft dynamic time warping distance, so as to extract characteristics of the signature to be authenticated and calculate a dynamic time warping distance to judge an authenticity.

In order to achieve above purposes, the application provides following schemes:
an online signature authentication system based on soft dynamic time warping includes
a data acquisition module, a data preprocessing module, a signature sequence feature extraction neural network module and a signature sequence feature testing module.

The data acquisition module is used for acquiring a signature sequence to be tested;
the data preprocessing module is used for preprocessing the signature sequence, acquiring preprocessed data and extracting time functions of the signature sequence;
the signature sequence feature extraction neural network module is used for constructing a neural network and training the neural network based on the time functions of the signature sequence to obtain a signature sequence feature extraction neural network; and
a signature sequence feature verification model is used for judging an authenticity by calculating a dynamic time warping distance between features of the signature sequence based on the preprocessed data and through the signature sequence feature extraction neural network.

Optionally, the time functions of the signature sequence in the data preprocessing module include: an horizontal speed vₓ and a vertical speed v_{y}, an angle θ and functions cos(θ) and sin(θ) thereof, a pressure p, a first difference \dot{v} of a speed v and a first difference \dot{θ} of the angle θ, a logarithmic curvature radius ρ, a centripetal acceleration c and a total acceleration α.

Optionally, the neural network in the signature sequence feature extraction neural network module consists of one-dimensional convolution layers, circulation layers and a fully connected layer; a rectified linear unit (ReLU) activation function is used after each convolution layer, and a maximum pooling layer is inserted between the convolution layers.

Optionally, the circulation layer in the signature sequence feature extraction neural network module is composed of gated autoregressive units,
an input at a time point t is iₜ and an output is oₜ, and the gated autoregressive units update their outputs as follows:

rₜ=sigmoid(Wᵣ×iₜ+Uᵣ×oₜ₋₁+bᵣ)

oₜ=tanh(Wₒ×iₜ+Uₒ×(rₜ⊙oₜ₋₁)+bₒ)

where rₜ represents a reset gate, Wᵣ, Uᵣ, Wₒ, and Uₒ are parameter matrix, bᵣ and bₒ are bias terms, and the gated autoregressive units only adopt the reset gate rₜ.

Optionally, a method for training the neural network in the signature sequence feature extraction neural network module includes:
calculating a soft dynamic time warping distance of a signature pair, and making X=[x₁, x₂, . . . , xₗ]ϵ [symbol] ^{d×l} and Y=[y₁, y₂, . . . , yₗ]ϵ [symbol] ^{d×m} as two signature sequences with a length l and a length m respectively, xᵢ and yᵢ as local feature vectors of a dimension d, and a loss matrix between column vectors of sequences X and Y as Δ(X, Y)ϵ [symbol] ^{l×m}, where [Δ(X, Y)]_{i,j}=∥xᵢ−yᵢ∥₂²; [symbol] _{l,m}⊂{0,1}^{l×m} is defined as a set of feasible binary alignment matrices, Aϵ [symbol] _{l,m} is a binary alignment matrix, which satisfies a boundary condition [A]_{1×1}=[A]_{l×m}=1 and is monotonic and incremental, and the soft dynamic time warping distance of the signature sequence pair X and Y is:

dtw_{γ}(X, Y)=min^{γ}{ [symbol] A, Δ(X, Y) [symbol] , Aϵ [symbol] _{l,m}}

where [symbol] A, Δ(X, Y) [symbol] represents an inner product of A and Δ(X, Y), min^{γ} is a generalized operator min with smoothing parameters defined as follows:

$${min}^{γ} {a}_{1} , … , {a}_{n} = \{ \begin{matrix}{min}_{i = 1 , … , n} {a}_{i} \\ - γ log {\sum }_{i = 1}^{n} {e}^{- {a}_{i} / γ}\end{matrix}$$

Assuming the neural network as a function ƒ(·), for the signature sequence pair X and Y, a following distance based on the soft dynamic time warping is used in a training stage:

$${d}_{train} ( X , Y ) = \frac{{dtw}_{γ} ( f ( X ) , f ( Y ) )}{\vert f ( X ) \vert + \vert f ( Y ) \vert}$$

where |·| represents a length of the signature sequence,
the soft dynamic time warping distance of the signature pair is integrated into a triplet loss function, and the neural network is trained based on the triplet loss function.

Optionally, in the signature sequence feature verification model, a method for calculating the dynamic time warping distance between the signature sequence features to judge the authenticity includes:
extracting features based on the preprocessed data and the obtained neural network,
calculating the distance between signature sequence features based on the dynamic time warping;

$${d}_{test} ( X , Y ) = \frac{dtw ( f ( X ) , f ( Y ) )}{\vert f ( X ) \vert + \vert f ( Y ) \vert}$$

where dtw(X, Y) is the dynamic time warping distance between two sequences calculated as follows:

$$d t w ( X , Y ) = {min}_{A ϵ {𝒜}_{l , m}} 〈 A , Δ ( X , Y ) 〉 ;$$

and
comparing dₜₑₛₜ(X, Y) with a preset threshold to obtain an authentication result.

In order to better achieve the above technical effects, the application also provides an online signature authentication method based on soft dynamic time warping, which specifically includes the following steps:
acquiring the signature sequence to be tested;
preprocessing the signature sequence, acquiring the preprocessed data and extracting the time functions of the signature sequence;
constructing the neural network and training the neural network based on the time functions of the signature sequence to obtain the signature sequence feature extraction neural network;
judging the authenticity by calculating the dynamic time warping distance between features of the signature sequence based on the preprocessed data and through the signature sequence feature extraction neural network.

Optionally, the time functions of the signature sequence include: the horizontal speed vₓ and the vertical speed v_{y}, the angle θ and functions cos(θ) and sin(θ) thereof, the pressure p, the first difference \dot{v} of the speed v and the first difference \dot{θ} of the angle θ, the logarithmic curvature radius ρ, the centripetal acceleration c and the total acceleration α.

Optionally, the neural network in the signature sequence feature extraction neural network module consists of the one-dimensional convolution layers, the circulation layers and the fully connected layer, the ReLU activation function is used after each convolution layer, and the maximum pooling layer is inserted between the convolution layers.

Optionally, the circulation layer in the signature sequence feature extraction neural network module is composed of gated autoregressive units, the specific mechanism is as follows,
the input at the time point t is iₜ and the output is oₜ, and the gated autoregressive units update their outputs as follows:

rₜ=sigmoid(Wᵣ×iₜ+Uᵣ×oₜ₋₁+bᵣ)

oₜ=tanh(Wₒ×iₜ+Uₒ×(rₜ⊙oₜ₋₁)+bₒ)
where rₜ represents a reset gate, Wᵣ, Uᵣ, Wₒ, and Uₒ are parameter matrix, bᵣ and bₒ are bias terms, and the gated autoregressive units only adopt the reset gate rₜ, and removes an update gate.

The application has following beneficial effects: the application discloses an online signature authentication system and an online signature authentication method based on soft dynamic time warping, and realizes a fusion of the neural network and a classical dynamic time warping algorithm by introducing a differentiable soft dynamic time warping algorithm, so that the neural network can carry out end-to-end trainings, thereby achieving a high-precision online signature authentication effect. The application has characteristics of high accuracy and strong generalization, and has higher application value.

### BRIEF DESCRIPTION OF THE DRAWINGS

In order to explain the technical scheme of the application more clearly, drawings needed in embodiments are briefly introduced below. Obviously, the drawings in the following description are only some embodiments of this application. For ordinary technicians in this field, other drawings may be obtained according to these drawings without paying creative labor.

FIG. 1 is a schematic composition diagram of a system according to an embodiment of the application.

FIG. 2 is a schematic diagram of an online signature authentication example according to the embodiment of the application.

FIG. 3 is a schematic flow chart of a method according to the embodiment of the application.

### DETAILED DESCRIPTION

In the following, the technical scheme in the embodiment of the application will be clearly and completely described with reference to the drawings in the embodiment of the application. Obviously, the described embodiment is only a part of the embodiment of the application, but not the whole embodiment. Based on the embodiments in this application, all other embodiments obtained by ordinary technicians in this field without creative work belong to the protection scope of this application.

In order to make the above objects, features and advantages of this application more obvious and easier to understand, the application is further described in detail with the attached drawings and specific embodiments.

Embodiment 1

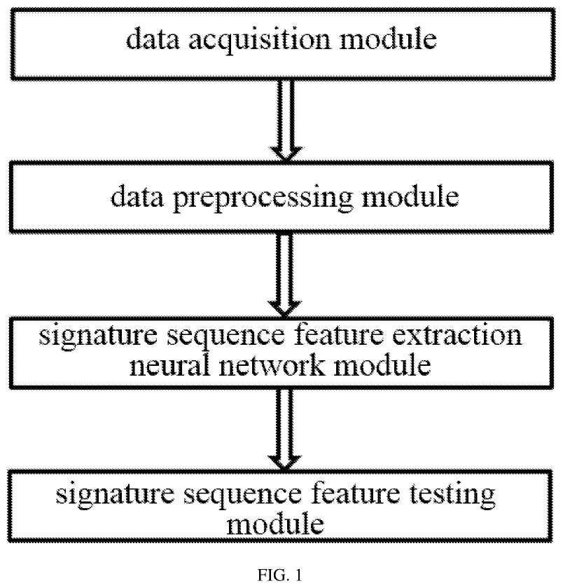

As shown in FIG. 1, an online signature authentication system based on soft dynamic time warping specifically includes:
a data acquisition module, a data preprocessing module, a signature sequence feature extraction neural network module and a signature sequence feature testing module.

The data acquisition module is used for acquiring a signature sequence to be tested;
the data preprocessing module is used for preprocessing the signature sequence, acquiring preprocessed data and extracting time functions of the signature sequence;
the signature sequence feature extraction neural network module is used for constructing a neural network and training the neural network based on the time functions of the signature sequence to obtain a signature sequence feature extraction neural network; and
a signature sequence feature verification model is used for judging an authenticity by calculating a dynamic time warping distance between features of the signature sequence based on the preprocessed data and through the signature sequence feature extraction neural network;
the time functions of the signature sequence in the data preprocessing module include: an horizontal speed vₓ and a vertical speed v_{y}, an angle θ and functions cos(θ) and sin(θ) thereof, a pressure p, a first difference \dot{v} of a speed v and a first difference \dot{θ} of the angle θ, a logarithmic curvature radius ρ, a centripetal acceleration c and a total acceleration α.

In this embodiment, in order to better achieve the above technical effects, it specifically includes:
using smart phones, electronic handwriting tablets and other devices as the data acquisition module to acquire the signature sequence; and
then preprocessing the signature sequence by the data preprocessing module. Specifically, preprocessing steps of the data preprocessing module include:
step 2.1, taking a statistics median value in the original coordinate as a center, carrying out a size normalization on the signature sequence; and
step 2.2, resampling the signature sequence to 100 Hz.

The time functions are calculated in the preprocessed signature sequence, including the horizontal speed vₓ and the vertical speed v_{y}, the angle θ and functions cos(θ) and sin(θ) thereof, the pressure p, the first difference \dot{v} of the speed v and the first difference \dot{θ} of the angle θ, the logarithmic curvature radius ρ, the centripetal acceleration c and the total acceleration α.

vₓ=xₜ₊₁−xₜ (1)

v_{y}=yₜ₊₁−yₜ (2)

v=\sqrt{vₓ²+v_{y}²} (3)

θ=arctan(v_{y}/vₓ) (4)

ρ=log(v/\dot{θ}) (5)

c=v·\dot{θ} (6)

α=\sqrt{\dot{v}²+c²} (7)
where t is a sampling time point of a sampling point. The time functions are normalized to a mean value of 0 and a variance of 1.

In this embodiment, steps of constructing a neural network for extracting signature sequence features in the signature sequence feature extraction neural network module include:

The time functions calculated in the step 3.1 are used as inputs of the neural network, the neural network consists of two one-dimensional convolution layers, two circulation layers and a fully connected layer. An ReLU activation function is used after each convolution layer, and a maximum pooling layer is inserted between the two convolution layers, and the signature sequence is downsampled twice. The specific network structure used is shown in Table 1:

TABLE 1

| Number | | |
|---|---|---|
| of layers | Structure | Configuration |
| 1 | convolution layer | 64 channels, core size 7, |
| | | step size 1, append edge 3 |
| 2 | maximum pooling | core size 2, step size 2 |
| | layer | |
| 3 | convolution layer | 128 channels, core size 3, |
| | | step size 1, append edge 1 |
| 4 | randomly dropping | probability 0.1 |
| 5 | circulation layer | 128 gated autoregressive |
| | | units |
| 6 | randomly dropping | probability 0.1 |
| 7 | circulation layer | 128 gated autoregressive |
| | | units |
| 8 | fully connected layer | 64 channels |

The circulating layer is composed of gated autoregressive units, and the specific mechanism is as follows: the input at time t is iₜ and the output is oₜ, and the gated autoregressive units update their output as follows:

rₜ=sigmoid(Wᵣ×iₜ+Uᵣ×oₜ₋₁+bᵣ) (8)

oₜ=tanh(Wₒ×iₜ+Uₒ×(rₜ⊙oₜ₋₁)+bₒ) (9)
where rₜ represents a reset gate, Wᵣ, Uᵣ, Wₒ, and Uₒ are parameter matrix, bᵣ and bₒ are bias terms, and the gated autoregressive units only adopt the reset gate rₜ and remove the update gate.

Step 3.2, inputting the time functions of the signature into the network according to a sampling mode of a triple, integrating the soft dynamic time warping distance of the signature pair into a loss function of the triple, and training the neural network by optimizing the loss function, including following steps: step 3.2.1: calculating the soft dynamic time warping distance of the signature pair. Making X=[x₁, x₂, . . . , xₗ]ϵ [symbol] ^{d×l} and Y=[y₁, y₂, . . . , yₗ]ϵ [symbol] ^{d×m} as two signature sequences with a lengths l and m respectively, xᵢ and yᵢ as local feature vectors of a dimension d, and the loss matrix between the column vectors of sequences X and Y as Δ(X, Y)ϵ [symbol] ^{l×m}, where [Δ(X, Y)]_{i,j}=∥xᵢ−yᵢ∥₂²; [symbol] _{l,m}⊂{0,1}^{l×m} is defined as a set of feasible binary alignment matrices, Aϵ [symbol] _{l,m} is a binary alignment matrix, which satisfies a boundary condition [A]_{1×1}=[A]_{l×m}=1 and is monotonic and incremental, and the soft dynamic time warping distance of the signature sequence pair X and Y is:

dtw_{γ}(X, Y)=min^{γ}{ [symbol] A, Δ(X, Y) [symbol] , Aϵ [symbol] _{l,m}} (10)
where [symbol] A, Δ(X, Y) [symbol] represents an inner product of A and Δ(X, Y), min^{γ} is a generalized operator min with smoothing parameters, which is defined as follows:

$${min}^{γ} {a}_{1} , … , {a}_{n} = \{ \begin{matrix}{min}_{i = 1 , … , n} {a}_{i} \\ - γ log {\sum }_{i = 1}^{n} {e}^{- {a}_{i} / γ}\end{matrix} \qquad ( 11 )$$

assuming the neural network described in the step 3.1 in the signature sequence feature extraction neural network module as a function ƒ(·), and for the signature sequence pair X and Y, the following distance based on the soft dynamic time warping is used in the training stage:

$${d}_{train} ( X , Y ) = \frac{{dtw}_{γ} ( f ( X ) , f ( Y ) )}{\vert f ( X ) \vert + \vert f ( Y ) \vert} \qquad ( 12 )$$

where |·| represents the length of the signature sequence.

Step 3.2.2, the soft dynamic time warping distance of the signature pair is integrated into a triplet loss function. Assuming that each data batch samples n_{w} different users in total, for the k-th user (k=1, . . . , n_{w}), a real signature Xₐ^{k} is sampled as the anchor point, the other n_{g} real signatures {X_{g,i}^{k}, i=1, . . . , n_{g}} as the positive sample, and n_{ƒ} random forged signatures or skilled forged signatures {X_{ƒ,j}^{k}, i=1, . . . , n_{ƒ}} as the negative sample. Therefore, for each user, there are n_{g}×n_{ƒ} triples. The soft dynamic time warping distance described in step 4.1 is integrated into the triplet loss function of the k-th user, and is calculated as follows:

$${L}_{k} = \frac{{\sum }_{i = 1}^{{n}_{g}} {\sum }_{j = 1}^{{n}_{f}} R e L U ( {d}_{t r a i n} ( {X}_{a}^{k} , {X}_{g , i}^{k} ) + ξ - {d}_{t r a i n} ( {X}_{a}^{k} , {X}_{f , j}^{k} ) )}{1 + {\sum }_{i = 1}^{{n}_{g}} {\sum }_{j = 1}^{{n}_{f}} \prod \{ R e L U ( {d}_{t r a i n} ( {X}_{a}^{k} , {X}_{g , i}^{k} ) + ξ - {d}_{t r a i n} ( {X}_{a}^{k} , {X}_{f , j}^{k} ) ) > 0 \}} \qquad ( 13 )$$

where ξ is a non-negative interval parameter. An overall loss function for training the

neural network is:

$$L = \frac{1}{{n}_{w}} {\sum }_{k = 1}^{{n}_{w}} ( {L}_{k} + \frac{λ}{{n}_{g}} {\sum }_{i = 1}^{{n}_{g}} {d}_{train} ( {X}_{a}^{k} , {X}_{g , i}^{k} ) ) \qquad ( 14 )$$

where the second term represents an intra-class difference of the real signatures, and its strength is controlled by a parameter λ.

Step 3.3, the neural network is trained by optimizing the loss function calculated in the step 3.2, and a random gradient descent optimizer is used, each training iteration is 20 times, an initial learning rate is set to 0.01, and the learning rate of each iteration is attenuated by an index of 0.9. The number of sampled users n_{w} is 4, the number of real signatures n_{g} is 5, and the number of forged signatures n_{ƒ} is 10, including 5 skilled forged signatures and 5 random forged signatures. ξ of the formula (13) is set to 1.0, and λ of the formula (14) is set to 0.9.

In this embodiment, the signature sequence features in the signature sequence feature testing module are tested in following ways:
for the signature sequence to be authenticated and the template signature sequence of a claimed identity in the signature sequence feature verification model, after data acquisition and data preprocessing, the neural network trained in the signature sequence feature extraction neural network module is used for extracting features, and the dynamic time warping distance between the signature sequence features is calculated to judge authenticity, including the following steps:
step 4.1, the signature sequence to be authenticated and the template signature sequence of the claimed identity are processed by the data preprocessing module; and
step 4.2, the neural network trained in the signature sequence feature extraction neural network module is used for extracting features, and the following distance between signature sequence features based on dynamic time warping is calculated:

$${d}_{test} ( X , Y ) = \frac{dtw ( f ( X ) , f ( Y ) )}{\vert f ( X ) \vert + \vert f ( Y ) \vert} \qquad ( 15 )$$

Where dtw(X, Y) is the dynamic time warping distance between two sequences,

which is calculated as follows:

$$dtw ( X , Y ) = {min}_{A ϵ {𝒜}_{l , m}} 〈 A , Δ ( X , Y ) 〉 \qquad ( 16 )$$

dₜₑₛₜ(X, Y) is compared with the preset threshold, and the authentication result is obtained.

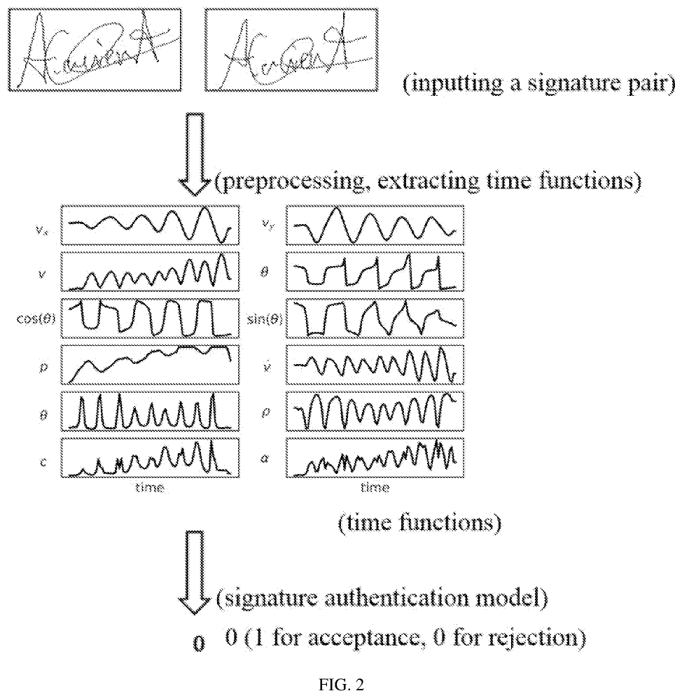

The accurate authentication result of online signature is shown in FIG. 2.

Embodiment 2:

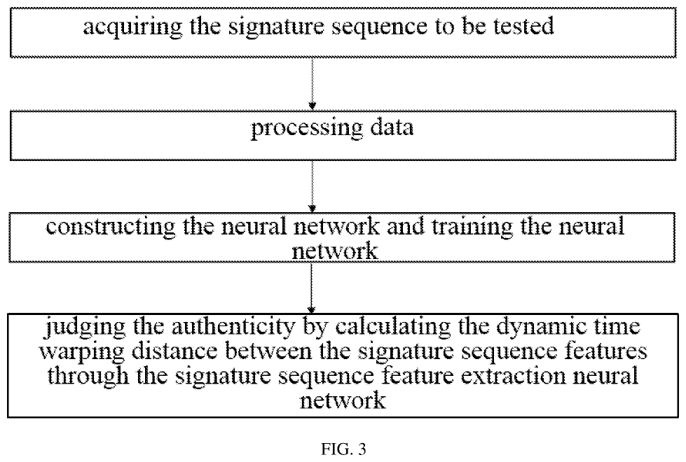

As shown in FIG. 3, an online signature authentication method based on soft dynamic time warping specifically includes the following steps:
step 1, acquiring the signature sequence to be tested;
step 2, preprocessing the signature sequence, acquiring the preprocessed data and extracting the time functions of the signature sequence; the time functions of the signature sequence include: the horizontal speed vₓ and the vertical speed v_{y}, the angle θ and functions cos(θ) and sin(θ) thereof, the pressure p, the first difference \dot{v} of the speed v and the first difference \dot{θ} of the angle θ, the logarithmic curvature radius ρ, the centripetal acceleration c and the total acceleration α.

step 3, constructing the neural network and training the neural network based on the time functions of the signature sequence to obtain the signature sequence feature extraction neural network; the neural network consists of the one-dimensional convolution layers, the circulation layers and the fully connected layer, the ReLU activation function is used after each convolution layer, and the maximum pooling layer is inserted between the convolution layers.

The circulation layer is composed of gated autoregressive units, and the specific mechanism is as follows,

an input at a time point t is iₜ and an output is oₜ, and the gated autoregressive units update their outputs as follows:

rₜ=sigmoid(Wᵣ×iₜ+Uᵣ×oₜ₋₁+bᵣ) (17)

oₜ=tanh(Wₒ×iₜ+Uₒ×(rₜ⊙oₜ₋₁)+bₒ) (18)
where rₜ represents a reset gate, Wᵣ, Uᵣ, Wₒ, and Uₒ are parameter matrix, bᵣ and bₒ are bias terms, and the gated autoregressive units only adopt the reset gate rₜ, and remove an update gate.
step 4, based on the preprocessed data and through the signature sequence feature extraction neural network, judging the authenticity by calculating the dynamic time warping distance between the signature sequence features.

Compared with the existing deep signature authentication method based on dynamic time warping, the application has the following advantages:

The application introduces the differentiable soft dynamic time warping distance, so that the neural network may be trained end to end, thus learning more effective signature representation;

In the training stage, the soft dynamic time warping distance is used, and multiple paths are comprehensively considered, so the neural network may have better loss during training; in the testing stage, dynamic time is used to regulate the distance and give a clear optimal path. This strategy may effectively improve the performance of signature authentication;

The method of the application has high authentication precision, strong adaptability to handwriting pen input, finger input, skilled forgery scene and random forgery scene, and good generalization performance to open set data;

The method may be applied to other online handwriting analysis tasks, such as writer identification based on online handwritten letters and identity authentication based on online handwritten numbers.

The above-mentioned embodiment is only a description of the preferred mode of this application, not a limitation on the scope of this application. Without departing from the design spirit of this application, various modifications and improvements made by ordinary technicians in this field to the technical scheme of this application shall fall within the protection scope determined by the claims of this application.

What is claimed is:

1. An online signature authentication system based on soft dynamic time warping, comprising,
a data acquisition module, a data preprocessing module, a signature sequence feature extraction neural network module and a signature sequence feature testing module;
wherein the data acquisition module is used for acquiring a signature sequence to be tested;
the data preprocessing module is used for preprocessing the signature sequence, acquiring preprocessed data and extracting time functions of the signature sequence;
the signature sequence feature extraction neural network module is used for constructing a neural network and training the neural network based on the time functions of the signature sequence to obtain a signature sequence feature extraction neural network; and
a signature sequence feature verification model is used for judging an authenticity by calculating a dynamic time warping distance between features of the signature sequence based on the preprocessed data and through the signature sequence feature extraction neural network.

2. The online signature authentication system based on soft dynamic time warping according to claim 1, wherein the time functions of the signature sequence in the data preprocessing module comprise: an horizontal speed vₓ and a vertical speed v_{y}, an angle θ and functions cos(θ) and sin(θ) thereof, a pressure p, a first difference \dot{v} of a speed v and a first difference \dot{θ} of the angle θ, a logarithmic curvature radius ρ, a centripetal acceleration c and a total acceleration α.

3. The online signature authentication system based on soft dynamic time warping according to claim 1, wherein the neural network in the signature sequence feature extraction neural network module comprises one-dimensional convolution layers, circulation layers and a fully connected layer; a rectified linear unit (ReLU) activation function is used after each convolution layer, and a maximum pooling layer is inserted between the convolution layers.

4. The online signature authentication system based on soft dynamic time warping according to claim 3, wherein the circulation layer in the signature sequence feature extraction neural network module comprises gated autoregressive units, and
an input at a time point t is iₜ and an output is oₜ, and the gated autoregressive units update their outputs as follows:
rₜ=sigmoid(Wᵣ×iₜ+Uᵣ×oₜ₋₁+bᵣ)
oₜ=tanh(Wₒ×iₜ+Uₒ×(rₜ⊙oₜ₋₁)+bₒ)
wherein rₜ represents a reset gate, Wᵣ, Uᵣ, Wₒ, and Uₒ are parameter matrix, bᵣ and bₒ are bias terms, and the gated autoregressive units only adopt the reset gate rₜ.

5. The online signature authentication system based on soft dynamic time warping according to claim 1, wherein a method for training the neural network in the signature sequence feature extraction neural network module comprises:
calculating a soft dynamic time warping distance of a signature pair, and making X=[x₁, x₂, . . . , xₗ]ϵ [symbol] ^{d×l} and Y=[y₁, y₂, . . . , yₗ]ϵ [symbol] ^{d×m} as two signature sequences with a length l and a length m respectively, xᵢ and yᵢ as local feature vectors of a dimension d, and a loss matrix between column vectors of sequences X and Y as Δ(X, Y)ϵ [symbol] ^{l×m}, wherein [Δ(X, Y)]_{i,j}=∥xᵢ−yᵢ∥₂²; [symbol] _{l,m}⊂{0,1}^{l×m} is defined as a set of feasible binary alignment matrices, Aϵ [symbol] _{l,m} is a binary alignment matrix, which satisfies a boundary condition [A]_{1×1}=[A]_{l×m}=1 and is monotonic and incremental, and the soft dynamic time warping distance of a signature sequence pair X and Y is:
dtw_{γ}(X, Y)=min^{γ}{ [symbol] A, Δ(X, Y) [symbol] , Aϵ [symbol] _{l,m}};
where [symbol] A, Δ(X, Y) [symbol] represents an inner product of A and Δ(X, Y), min^{γ} is a generalized operator min with smoothing parameters defined as follows:
$${min}^{γ} {a}_{1} , … , {a}_{n} = \{ \begin{matrix}{min}_{i = 1 , … , n} {a}_{i} \\ - γ log {\sum }_{i = 1}^{n} {e}^{- {a}_{i} / γ}\end{matrix} ;$$
assuming the neural network as a function ƒ(·), for the signature sequence pair X and Y, a following distance based on the soft dynamic time warping is used in a training stage:
$${d}_{train} ( X , Y ) = \frac{{dtw}_{γ} ( f ( X ) , f ( Y ) )}{\vert f ( X ) \vert + \vert f ( Y ) \vert} ;$$
where |·| represents the length of the signature sequence,
the soft dynamic time warping distance of the signature pair is integrated into a triplet loss function, and the neural network is trained based on the triplet loss function.

6. The online signature authentication system based on soft dynamic time warping according to claim 1, wherein in the signature sequence feature verification model, a method for calculating the dynamic time warping distance between the signature sequence features to judge the authenticity comprises:
extracting features based on the preprocessed data and the obtained neural network;
calculating the distance between signature sequence features based on dynamic time warping,
$${d}_{test} ( X , Y ) = \frac{dtw ( f ( X ) , f ( Y ) )}{\vert f ( X ) \vert + \vert f ( Y ) \vert} ;$$
wherein dtw(X, Y) is the dynamic time warping distance between two sequences calculated as follows:
$$dtw ( X , Y ) = {min}_{A ϵ {𝒜}_{l , m}} 〈 A , Δ ( X , Y ) 〉 ;$$
and
comparing dₜₑₛₜ(X, Y) with a preset threshold to obtain an authentication result.

7. An online signature authentication method based on soft dynamic time warping, comprising,
acquiring a signature sequence to be tested;
preprocessing the signature sequence, acquiring preprocessed data and extracting time functions of the signature sequence;
constructing a neural network and training the neural network based on the time functions of the signature sequence to obtain a signature sequence feature extraction neural network; and
judging an authenticity by calculating a dynamic time warping distance between features of the signature sequence based on the preprocessed data and through the signature sequence feature extraction neural network.

8. The online signature authentication method based on soft dynamic time warping according to claim 7, wherein
the time functions of the signature sequence comprise: a horizontal speed vₓ and a vertical speed v_{y}, an angle θ and functions cos(θ) and sin(θ) thereof, a pressure p, a first difference \dot{v} of the speed v and a first difference \dot{θ} of the angle θ, a logarithmic curvature radius ρ, a centripetal acceleration c and a total acceleration α.

9. The online signature authentication method based on soft dynamic time warping according to claim 7, wherein
the neural network in the signature sequence feature extraction neural network module comprises one-dimensional convolution layers, circulation layers and a fully connected layer, an ReLU activation function is used after each convolution layer, and a maximum pooling layer is inserted between the convolution layers.

10. The online signature authentication method based on soft dynamic time warping according to claim 9, wherein
the circulation layer in the signature sequence feature extraction neural network module comprises gated autoregressive units, a specific mechanism is as follows,
an input at a time point t is iₜ and an output is oₜ, and the gated autoregressive units update outputs as follows:
rₜ=sigmoid(Wᵣ×iₜ+Uᵣ×oₜ₋₁+bᵣ)
oₜ=tanh(Wₒ×iₜ+Uₒ×(rₜ⊙oₜ₋₁)+bₒ)
wherein rₜ represents a reset gate, Wᵣ, Uᵣ, Wₒ, and Uₒ are parameter matrix, bᵣ and bₒ are bias terms, and the gated autoregressive units only adopt the reset gate rₜ, and remove an update gate.
